(19) United States
(12) Patent Application Publication
(10) Pub. No.: US 2010/0197182 A1
(43) Pub. Date: Aug. 5, 2010

(54) FIRE RESISTANT BUILDING ELEMENT AND PLASTER THEREFOR

(76) Inventor: Zvi Barzilai, Caesarea (IL)

Correspondence Address: YORAM TSIVION, P.O. BOX 1307, PARDES HANNA, 37111, IL

(21) Appl. No.: 12/668,667

(22) PCT Filed: Jul. 10, 2008
(86) PCT No.: PCT/IL2008/000951

§ 371 Date: Jan. 12, 2010

Related U.S. Application Data
(60) Provisional application No. 60/949,247, filed on Jul. 12, 2007.

(51) Int. Cl. E04B 1/94; B32B 9/04; B32B 3/26; C04B 11/00

(52) U.S. Cl. 442/1; 428/702; 428/304.4; 106/772; 524/8

(57) ABSTRACT

A laminate board for building element to be used in the construction of buildings includes a core layer made of moisture-impermeable polymers, and one or more external layer, facing and attached to the core layer wherein the external layer includes a fibre net and a mixture of construction materials and flame-retarding materials.

### RELATED APPLICATION DATA

This application is a continuation in part of International Patent Application No. PCT/IL2008/000951, entitled “FLAME-RETARDANTS FOR BUILDING ELEMENTS”, which was filed on Jul. 10, 2008, which claims the benefit of the filing date of U.S. provisional patent application 60/949,247, entitled “FLAME-RETARDANTS FOR BUILDING ELEMENTS”, filed on Jul. 12, 2007, the entire disclosures of which are incorporated by reference herein in their entirety.

### FIELD OF THE INVENTION

The present invention relates to a building element and plaster therefor, in particular exhibiting fire resistant qualities.

### BACKGROUND OF THE INVENTION

Flame-retardants are materials that inhibit or resist the ignition and spread of fire. One way to stop spreading of a flame over a material is to create a thermal insulation barrier between the burning and unburned portions. Intumescent additives are often employed, which turn a polymer into a thermally insulating foam when exposed to fire. They separate the flame from the un-burnt material and slow the heat transfer typically by forming a strong and stable char which prevents further flame propagation.

Flame-retardants have been employed in the construction industry to enhance the safety of buildings. Several different types of flame-retarding treatments are known in the art. For example, one type of treatment involves coating the surface of the building element with a flame-retarding coating, and another type involves affixing of flame-retardant containing laminates to surfaces of building elements. As an additional benefit, such treatments may reduce the amount of smoke produced in a fire, and thus potentially lower the risk of smoke inhalation by persons in a burning structure.

One example of an implementation of a flame-retardant for electrical components and building wires is disclosed in the European patent, EP0015842*2B1. An elastomeric thermoplastic retardant is disclosed, which is a composition of polymeric components and mineral fillers such as: aluminium oxides and hydrates. Mineral fillers release water upon heating for improved flame retardancy. It is also known that mineral fillers can be treated with a coupling agent for improving the association with the filler(s) and polymeric component(s).

Halogenated flame-retardants are commonly employed as components in electronic and building elements to reduce the flammability of such elements. However, environmental issues associated with halogenated flame-retardants have caused concern in recent years. One particular aspect is the formation of toxic micro-pollutants in combustion processes. For example, the halogenated organic compounds, polybrominated dioxins and dibenzofurans, are formed during the pyrolysis of brominated flame-retardants. These heterocyclic organic compounds are very toxic chemicals with properties and chemical structures similar to dioxins.

### SUMMARY OF THE INVENTION

The present invention relates to a building element and plaster therefor, in particular exhibiting fire resistant qualities. The term “building element” and “board” may be used interchangeably throughout the specification and claims; and include, inter alia, building elements such as walls, flooring, ceilings, beams and so forth.

According to embodiments of one aspect of the invention, there is provided a building element, comprising: a core layer comprising a moisture-impermeable polymer; and at least one external layer, facing and attached to said core layer and including a mixture comprising at least one metal hydroxide in a concentration of 4-50% by weight of said external layer.

According to embodiments of another aspect of the invention, there is provided a plaster layer comprising at least one metal hydroxide in a concentration of 4-50% by weight of the plaster layer.

It is a particular feature of the invention that metal hydrates (for example: aluminum hydroxide (alumina tri-hydrate) and/or magnesium hydrate) in the composition of the plaster are used in a relatively high concentration in order to provide certain improvements, in particular to provide thermal insulation as well as flame retardancy. Without limitation to theory, it is believed that there is an enhanced insulation effect when using the aforementioned high concentration of metal hydrate(s).

In some embodiments, the plaster composition further comprises an expandable material such as a micaceous material (e.g. vermiculite) or perlite. Without limitation to theory, it is believed that there is a synergistic effect by combining aluminum hydroxide (or other metal hydroxide) and perlite and/or vermiculite (each between 10-50%), which is added to other components such as cement and sand to produce a plaster (or other coating or adhesive building material) intended for coating or covering a building element.

### BRIEF DESCRIPTION OF THE DRAWINGS

The present invention will be understood and appreciated more fully from the following detailed description taken in conjunction with the appended drawings in which:

FIG. 1 is a cross sectional view of an embodiment of a building element or board in accordance with the present invention;

FIG. 2 is a front view of another embodiment of the board comprising a reinforcing net; and

FIG. 3 is a cross sectional view of yet another embodiment of a board of the invention.

### DETAILED DESCRIPTION OF EMBODIMENTS OF THE PRESENT INVENTION

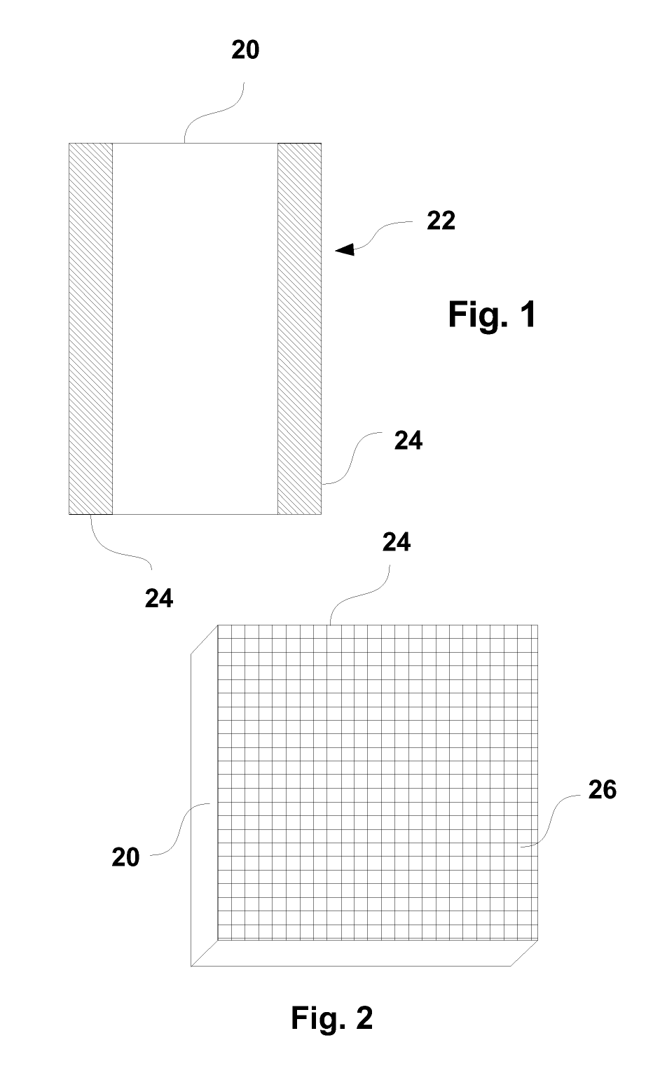

The present invention relates to building elements such as boards having a coating plaster for providing flame-retardation properties. An exemplary building element embodying the invention is a multi-layered (laminate) board, having a central layer typically sandwiched or faced on two sides by respective attached cover layers or a plurality thereof. The structure of such building element is explained further with reference to FIG. 1, wherein there is shown a central layer 20 of the board 22 in a cross sectional view, faced by two respective external layers 24. The two external layers 24 are both structural and protective, in that they provide strength to the construction, and protect the vulnerable central layer 20 from bending or cracking. The central layer 20 is made, for example, of moisture-impermeable polymers, such as extruded polystyrene foam.

As can be seen in FIG. 2, according to some embodiments, external layers 24 are reinforced using a net 26 comprising fibres. Typically, glass fibre is used, but other polymers may be used as well. Net 26 is coated with a mixture of materials, which include construction and flame-retardant components, such as: cement, quartz, chalk, metal hydroxides and hydrated metal oxides, typically magnesium hydroxide and alumina. In another aspect of the invention, the external layers 24 can also function as a primer for an additional coating such as plaster, used typically as coating for a wall.

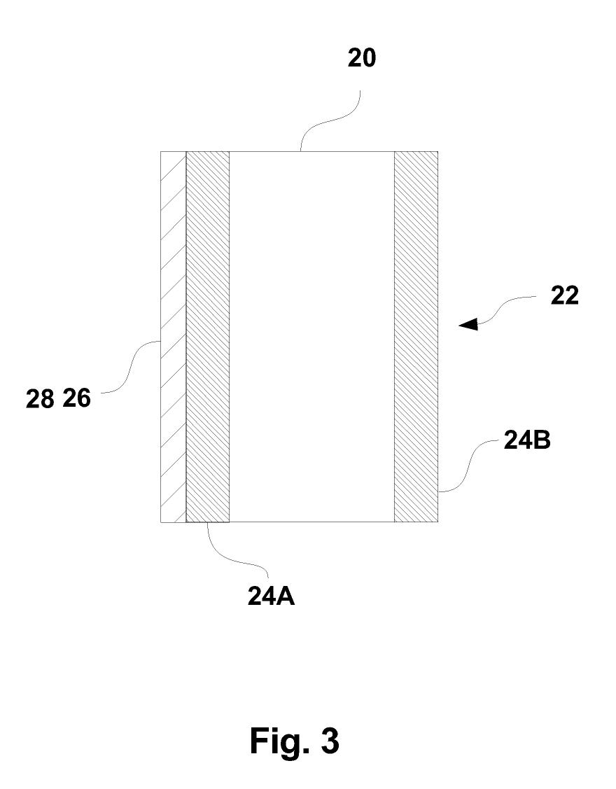

As can be seen in FIG. 3, plaster layer 28 is laid on one of the external layers 24 of the board, to provide a wall covering. This additional plaster layer 28 may have flame retardation traits on its own merit in addition to the flame retardation of layer 24.

An example of a metal hydrate flame retardant compound having particularly good thermal insulation properties is alumina tri-hydrate or aluminium hydroxide.

Regardless, in some embodiments, one or more additional thermal insulating materials are introduced into the mixture of flame retardant compounds for thermal insulation enhancement. Minerals, such as vermiculite, perlite or any other moisture expandable mineral materials can be suitable materials to enhance thermal insulation.

### Testing

Flammability: Tests were conducted in compliance with Underwriters laboratories (UL). In the tests, a specimen of a plaster layer was exposed to a flame under controlled laboratory conditions. The plaster layers attained the UL's flame spread class UL 94 V-0 that indicating a high resistance to ignition, none of the test samples having burned or emitted burning particles. Tests conducted in compliance with the British standard 476/7, examined the plaster layer's flammability as well. As judged by the British standard 476/7, the grade for the plaster layers attained Class 1 definition, the highest level.

Insulation: Plaster layers produced in accordance with the present invention, of 15 mm thickness and 30×30 cm, were exposed to fire on one side. The layer consisted of a mixture of cement and quartz-sand with aluminum hydroxide and perlite and/or vermiculite.

Various plaster layers having the following compositions were tested:

15-90% by weight of cement or gypsum (or mixture thereof)
2-50% aluminum hydroxide (alumina 3-hydrate)
5-50% silica sand
0.5-25% perlite (expanded alumina)

In some tests, the optional following components were added:
0.3-10% redispersible adhesive (liquid or powder) such as polyvinyl acetate (PVA); styrene butadiene rubber (SBR); styrene acrylic; and vinyl acetate ethylene copolymer:
rheological polymer thickener, such as 0.1-0.6% cellulose
2-50% magnesium hydroxide
3-20% expanded glass
0.5-25% vermiculite (expanded mica)
hydrated gypsum powder
0.1-1% fibers, for example synthetic, glass, nylon and/or polypropylene
0.5-1% alpha-olefin sulphonate sodium salt (“HOSTAPUR”)
hydrophobic materials, such as calcium sulfo-aluminate or polymerized melamine sulfonate.
2-3% Titanium oxide

In particular, the following two plaster formulations were tested:
a) Redispersible adhesive 1,000 g; cellulose 150 g; Portland cement 6,000 g; alumina 10,000 g; sand mixture 3,000 g; expanded glass 3,500 g; perlite 650 g; vermiculite 650 g; and fibers 50 g.
b) Redispersible adhesive 125 g; cellulose 125 g; Portland cement 6,250 g; alumina 5,000 g; sand mixture 5,000 g; expanded glass 3,500 g; perlite 2500 g; vermiculite 2,500 g; fibers 30 g.

Water was added to each formulation

The time and temperature at the other side of the plaster layer was measured until reaching 150 degrees Celsius. A first control layer tested was a thermal plaster layer. The temperature on the non-flame side of the standard thermal plaster reached 150 degrees Celsius in 15 minutes. A second control layer tested was a plaster having 1-2% aluminum hydroxide, which also reached 150 degrees Celsius in 15 minutes.

The result: both the standard plaster and the plaster including a low percentage of aluminum hydroxide heated more or less linearly, whereas the present plaster was stable at around 50-80 Celsius for approximately half an hour.

Until now, adding flame retardant material to the organic material of the plaster layer has primarily been used for flame retarding purposes. In contrast, in the present plaster layer, aluminum hydroxide (or other metal hydroxides), have been shown to be useful as an insulating material as well. When water is discharged from the aluminum hydroxide it cools the plaster. When combining the aluminum hydroxide with perlite, the plaster becomes even more insulating, delaying/reducing the heat transfer and protecting the building element that it coats/covers.

This embodiments disclosed can be broadened for use not only as plaster, but also to other wrapping systems, such as, adhesives; standard plaster; gypsum plaster (in which case no cement is needed); artificial stone and the like.

This plaster/plaster and board system is suitable for use having a range of coating thicknesses; for plaster, adhesive or other wrapping/coatings and board; and for use and implementation in-situ in the working site or factory.

1. A building element comprising:
a core layer comprising a moisture-impermeable polymer; and
at least one external layer, facing and attached to said core layer and including a mixture comprising at least one metal hydroxide in a concentration of 4-50% by weight of said external layer.

2. The element as in claim 1, comprising two external layers, the core layer disposed therebetween.

3. The element as in claim 1, wherein said moisture-impermeable polymer comprises an extruded polystyrene foam.

4. The element as in claim 1, further comprising a net made of a material selected from the group consisting of: fibreglass, organic polymers, inorganic polymers and a combination thereof.

5. The element as in claim 4, wherein said inorganic polymer is glass.

6. The element as in claim 1, wherein the external layer further comprises plastic additives, quartz, chalk, cement and any combination thereof.

7. The element as in claim 1, wherein said metal hydroxide comprises any one of alumina hydroxide, magnesium hydroxide, a hydrated metal oxide, and any combination thereof.

8. The element as in claim 7, wherein said hydrated metal oxide is alumina tri-hydrate.

9. A plaster layer comprising at least one metal hydroxide in a concentration of 4-50% by weight of the plaster layer.

10. The layer as in claim 9, wherein the metal hydroxide is aluminium hydroxide.

11. (canceled)

12. The layer as in claim 9, wherein the metal hydroxide is magnesium hydroxide.

13. The layer as in claim 9, further comprising 15-90% by weight of cement or gypsum, or a mixture thereof; 5-50% silica sand; and 0.5-25% perlite or vermiculite, or a mixture thereof.

14. The layer as in claim 9, further comprising: 0.3-10% redispersible adhesive; and/or 0.1-0.6% rheological polymer thickener; and/or 3-20% expanded glass; and/or hydrated gypsum powder; and/or 0.1-1% fibers; and/or 0.5-1% alpha-olefin sulphonate sodium salt; and/or hydrophobic materials; and/or 2-3% titanium oxide.

15. The layer as in claim 14, wherein the redispersible adhesive comprises: polyvinyl acetate; and/or styrene butadiene rubber; and/or styrene acrylic; and/or vinyl acetate ethylene copolymer.

16. The layer as in claim 14, wherein the rheological polymer thickener comprises cellulose.

17. The layer as in claim 14, wherein the fibers comprise: glass; and/or nylon; and/or polypropylene.
